(19) United States
(12) Patent Application Publication
(10) Pub. No.: US 2013/0129326 A1
(43) Pub. Date: May 23, 2013

(54) VIDEO PLAYER

(71) Applicants: Kai Wang, Beijing (CN); Yan Li, Beijing (CN); Manivel Sethu, Bangalore (IN); Pradeep Muruganandam, Pollachi (IN); Francois Martin, Paris (FR)

(72) Inventors: Kai Wang, Beijing (CN); Yan Li, Beijing (CN); Manivel Sethu, Bangalore (IN); Pradeep Muruganandam, Pollachi (IN); Francois Martin, Paris (FR)

(73) Assignee: NXP B.V., Eindhoven (NL)

(21) Appl. No.: 13/813,293

(22) PCT Filed: Jul. 12, 2011
(86) PCT No.: PCT/IB2011/002847

§ 371 Date: Jan. 30, 2013

(30) Foreign Application Priority Data
Aug. 4, 2010 (CN) PCT/CN2010/001186

(51) Int. Cl. H04N 7/26

(52) U.S. Cl. CPC H04N 19/00775
USPC 386/355

(57) ABSTRACT

A method for down sampling data comprising the steps of down-sampling the data; and carrying out a motion compensation step on the down-sampled data which motion compensation step is carried out in the frequency domain, further comprising the step of transforming the data back to the spatial domain after the step of motion compensation has been performed.

This invention relates to a down-sampling video player, to a decoder forming part of a video player, and to a method for down-sampling video data.

One of the major applications of a down-sampling video decoder/player is video in mobile devices such as mobile telephones which incorporate a camera and video recorder, for example.

Because of the limited processing capability of mobile devices, there is a need to develop a down-sampling video decoder/player in which the down-sampling of data is carried out as efficiently as possible in order to reduce the amount of computation required to down-sample the data.

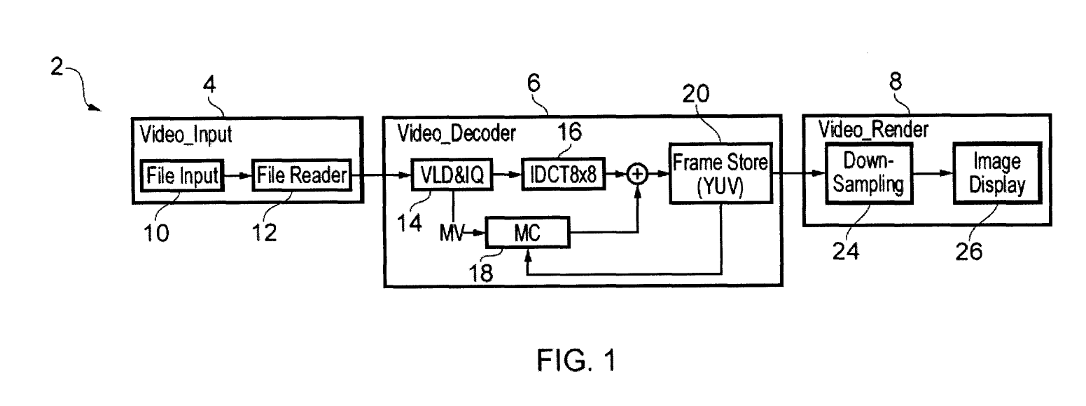

A known decoding process of a known down-sampling video player is based upon standard video decoding and rendering sequence. In the standard sequence, down-sampling of image data takes place in the spatial domain, as shown in FIG. 1. Such down-sampling does not result in a significant reduction of computation operations, and therefore is not always suitable for use in mobile devices.

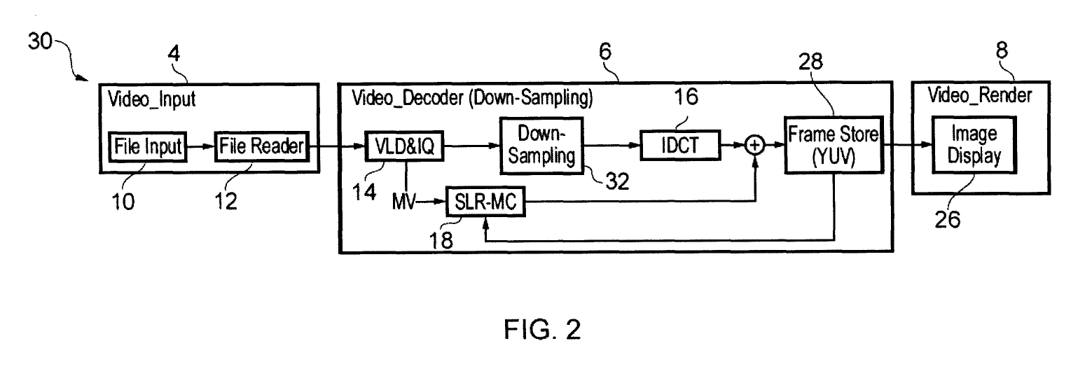

In order to overcome the problems associated with down-sampling in the spatial domain, it is also known to execute down-sampling within the decoder loop of the video player as shown schematically in FIG. 2, and to thus down-sample data in the frequency domain.

Such a configuration may result in a reduction of computation operation because the amount of data to be handled is reduced. This is because sub-sampling may be carried out in the transfer domain after VLD-IQ, and therefore the amount of data to be processed by the IDCT and the SLR-MC will be reduced. However, a disadvantage of such a configuration is that motion compensation (MC) is carried out using a mixture of full resolution motion vectors and down-sampled data. This can lead to serious artefacts. This effect is described in more detail in “On the Motion Compensation Within a Down-conversion Decoder” by Anthony Vetro and Huifang Sun, Mitsubishi Electric ITA, Advance Television Laboratory, SPIE Journal of Electronic Imaging, July 1998 (This paper will be referred to herein as Paper 1). Although the authors of this paper offer a methodology to derive a motion compensation filter for reducing such artifacts, hitherto there has not been a simple, elegant and effective motion compensation filter found that can serve the purpose of reducing the artefacts without defeating the purpose of reducing the computation requirements.

U.S. Pat. No. 5,708,732 describes a transcoding technique that employs fast DCT (Discrete Cosine Transform) down-sampling and inverse motion compensation.

In the system described in US '732, the down-sampling scheme chosen is based on a DCT domain realisation of spatial domain sub-sampling where a new sample point is obtained by the averaging of four adjacent points.

Each down-sampled 8×8 block is derived from four original adjacent 8×8 blocks. The coefficients of the down-sampled 8×8 block are obtained by bi-linear interpolation with the formula set out below. Every non-overlapping group of four pixels forming a small 2×2 block is replaced by one pixel whose intensity is the average of the four original pixels.

It is known that many image and video processing applications require real-time manipulation of digital image data or video data to implement, for example down-sampling. Real-time manipulation of the image and video data may be problematic since in many instances the data is available only in compressed form.

A known approach to dealing with compressed domain data is to first decompress the data to obtain a spatial domain representation, then apply the desired image or video manipulation technique such as down-sampling, and then compress the manipulated data so that a resulting bit stream conforms to an appropriate compression standard.

Many schemes to compress data use a so-called discrete cosine transform (DCT) to convert the original image data from the spatial domain to the compressed domain. Data must then be decompressed using the inverse DCT (IDCT) transform to convert it to YUV data.

In the case of the known technique described in U.S. Pat. No. 5,708,732, in order to avoid the extra steps of IDCT and DCT operations in the transcoding process, the down-sampling operation is performed in the DCT domain which is optimised with a fast matrix decomposition method. Such a method is however computationally complicated.

Further, in the system and method described in US '732, spatial domain motion compensation as set out equation (i) below:

$$\hat{x} = {\sum }_{i = 1}^{4} {c}_{i 1} {x}_{i} {c}_{i 2} \qquad ( i )$$

is realised in the DCT domain in accordance with equation ii below:

$$\hat{X} = {\sum }_{i = 1}^{4} {C}_{i 1} {X}_{i} {C}_{i 2} \qquad ( ii )$$

Where the reference frame Xi is derived from the coefficients of the original 8×8 DCT block.

Computation reduction in US '732 is achieved by exploiting the distribution sparseness of the matrix coefficients, with the original reference frame being used for motion compensation.

According to a first aspect of the present invention there is provided a method of decoding video data, comprising the steps of down-sampling the data in the frequency domain; and carrying out a motion compensation step on the down-sampled data, which motion compensation step is carried out in the frequency domain, further comprising the step of transforming the data back to the spatial domain after the step of motion compensation has been performed.

The present inventors have recognised that principles previously used only in transcoding applications can be applied for a different purpose in a video decoder/player.

A DCT transform is a mathematical function that transforms data from the spatial domain into the (spatial) frequency domain. In many video compression algorithms, the DCT is applied to 8×8 spatial blocks resulting in 8×8 frequency domain blocks. A feature of this 8×8 frequency domain block is that low frequency coefficients are concentrated around the (0,0) DCT coefficient while high frequency DCT coefficients are concentrated around the (7,7) DCT coefficient.

One way to carry out downsampling in the frequency domain is to preserve low DCT coefficients while discarding high frequency coefficients. One way to do this is to crop a sub-square block around the (0,0) DCT coefficient. The full downsampling process is then completed by performing a lower order Inverse DCT transform on the sub-square block. In summary: if we consider X(8,8) an 8 by 8 block of data in the spatial domain, Y(8,8)=DCT8(X(8,8)) the 8×8 DCT transform of X, also an 8 by 8 block, W(4,4)=Crop(Y(8,8)), the block resulting from the crop of Y around the coeff (0,0) and finally Z(4,4)=IDCT4(W(4,4)) the 4×4 inverse DCT transform of W, the overall process results in the down-sampling of X(8,8) in Z(4,4) by a factor of two in both vertical and horizontal direction.

There are other methods that may be used to transform data from the spatial domain to the frequency domain. It is to be understood, therefore, that this invention is not limited to the use of the DCT/IDCT to transform data to and from the frequency domain. Likewise, the usefulness of the invention is not limited to any specific block size.

An advantage of both the down-sampling and the motion compensation taking place in the frequency domain is that if the DCT is used to transform data to the frequency domain, energy in the DCT domain concentrates around a low frequency data area, down-sampling in the frequency domain can be carried out by taking only the low frequency components of the DCT.

One way in which such down-sampling may be carried out is by second order down-sampling. Here, “second order downsampling” refers to downsampling which retains (keeps) a set of coefficients in a more complex geometric pattern than a simple square sub-block. The second order down-sampling may be carried out on a N×N data block obtained from the first order down-sampling. Data obtained from second order down-sampling will not be limited to a rectangle or square data block and the data can be any data subset from N×N data block. This is advantageous since there is no limitation on from which subset of the N×N block data is obtained. This may increase the quality of the resulting image, for any given number of coefficients to be retained.

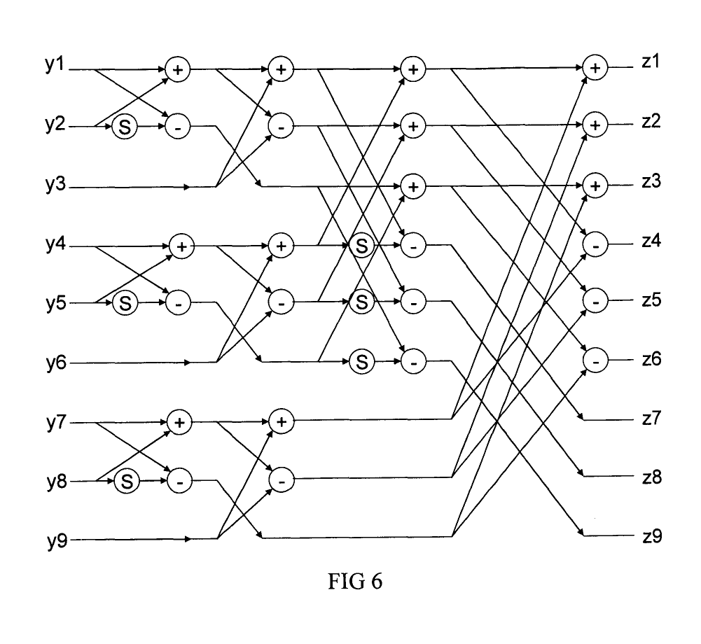

In an embodiment of the invention therefore, the step of down-sampling the data comprises a second order down-sampling process. In some embodiments of the invention, the down-sampling scheme used is scan-aligned down-sampling scheme, wherein the set of coefficients to be retained is defined according to the zig-zag scan that is used to order frequency coefficients in many conventional image and video compression algorithms. This is a specific sequential ordering of the DCT coefficients from (approximately) the lowest spatial frequency to the highest as shown in FIG. 5.

If a DCT is used to transform data from the spatial/time domain to the frequency domain such that down-sampling may be carried out in the frequency domain, then the step of transforming the data back to the spatial/time domain may be achieved by carrying out an inverse DCT (IDCT) on the data after motion compensation has been performed.

In other words, by means of the present invention it is possible to move the inverse transform, for example the IDCT, out of the decoder of a video player and into the renderer. This means that the decoder—and in particular the motion compensation loop of the decoder—may operate entirely in the frequency domain.

Further, since the inverse transform has been moved out of the decoding process, all reference data and current data will be in the frequency domain in the form of DCT coefficients, for example, and only the down-sampled DCT coefficient of a frame, and not the YUV data, will be stored during the decoding process.

This obviates the need to perform the inverse transform in the decoding loop.

Further, because the inverse transform may form part of the rendering process of a video player/system, the inverse transform may be performed on the data out only when necessary and may be viewed as a just-in time (JIT) or on-demand inverse transform.

In other words, when the inverse transform forms part of the decoding loop process as is the case with prior art systems, it is necessary to perform the inverse transform on all down-sampled data and then to carry out the motion compensation on the data in the spatial/time domain.

By means of the present invention, motion compensation is carried out on down-sampled data before that down-sampled data has been transformed back to the spatial/time domain. By changing the architecture of the system and carrying out the inverse transform process after the motion compensation step has been carried out on the down-sampled data, the inverse transform may be positioned within the video render. This in turn means that it is only necessary to convert data back to the spatial/time domain when necessary and on a just-in time basis. For example, if a user is going to to jump over parts of a video, then it will not be necessary to carry out the inverse transform on that data.

By means of the present invention therefore the amount of processing required to produce an image display is reduced thus making the invention particularly suitable for use in mobile devices.

The step of down-sampling the data preferably comprises retaining only a first partial set of coefficients from among a block of frequency-domain coefficients and discarding the other coefficients of the block, said first set being chosen according to a first pattern; and the step of transforming the data back to the spatial domain may comprise applying an inverse transform to a second set of frequency-domain coefficients, said second set being chosen according to a second, different pattern.

In this way, the resolution used in the motion-compensation loop can be independent of the resolution used in the inverse transform (for example, IDCT). This allows the decoder greater flexibility—for example, to quickly change the resolution of the displayed image, on demand, by changing the resolution of the inverse transform without changing the resolution of the down-sampling immediately.

The second set of coefficients may advantageously be a proper subset of the first set of coefficients.

The inventors have found that it is beneficial to use more coefficients in the motion compensation loop than in the inverse transform. Thus, the down-sampling of the frequency coefficients may retain all of the coefficients used in the inverse transform as well as some additional coefficients. The additional coefficients included may be those with the next highest frequencies—that is, the first pattern may include additional higher frequency coefficients which are adjacent to coefficients in the second pattern. The effect is that a higher image quality is maintained in the motion-compensation loop, which may help to reduce decoder-drift.

The step of down-sampling the data preferably comprises: retaining only a partial set of luma coefficients from among a block of frequency-domain luma coefficients; and retaining only a partial set of chroma coefficients from among a block of frequency-domain chroma coefficients, wherein the set of chroma coefficients contains fewer coefficients than the set of luma coefficients.

The inventors have recognised that artefacts due to down-sampling are less perceptible in the displayed video when they occur in the chrominance signal, compared with the luminance signal. Therefore, it is preferable to down-sample the chrominance relatively more aggressively, for a given overall computational budget.

The method may comprise decoding successive first and second frames of video data, wherein the step of transforming the data back to the spatial domain is performed at a first resolution for the first frame and a second, different resolution for the second frame.

This can enable rapid changes in resolution between consecutive frames. The resolution of the down-sampling (that is, the resolution in the motion-compensation loop) may change at the same time, or a different time.

The method may further comprise, in the step of transforming the data back to the spatial domain, applying additional processing to the video data as part of the inverse transform.

Here “additional” processing refers to image processing operations other than those necessary to invert the spatial frequency transform (which was used at the encoder to transform the image data into the frequency domain). Preferably, the inverse transform is decomposed into a series of simpler constituent calculations (for example, matrix multiplication operations), to obtain an efficient implementation. In this case, the additional processing operations are preferably achieved by modifying a first stage of the decomposition.

Because the present decoding method takes the inverse transform step out the motion-compensation loop, a frequency domain representation of each decoded frame is available. (In contrast, in a conventional decoder, only the motion-compensated frame-difference signal is available in the transform domain.) It can therefore be advantageous to apply processing operations to the decoded frame in the frequency domain. This may be because the down-sampling has reduced the volume of data to be manipulated and/or because certain operations are more efficient in the frequency domain. The present inventors have recognised that the efficiency of such processing operations can be further increased by combining them with the inverse transform itself.

The additional processing may comprise, for example: sharpening; blurring; rotating; mirroring; transposing; translating; brightness change; and contrast change of a frame of the video data.

In the step of down-sampling the data: a first number of coefficients may be retained in a first block in the interior of a frame; and a second, greater number of coefficients are retained in a second block at the border of the frame.

Some video coding standards allow motion vectors to refer to pixels in the reference frame which are outside the boundaries of the frame. Padding must be performed to derive reference values for these “out-of-bound” pixels. In embodiments of the present invention, the step of motion compensation comprises padding a block of data from a reference frame, which padding is performed in the frequency domain. Padding is preferably performed in the frequency domain, since it is desirable that the motion-compensation loop operates exclusively on frequency-domain coefficients. The inventors have recognised that the derived, padded values can be reconstructed more accurately if relatively more frequency coefficients are retained for blocks at the edges of the frame. Improving the accuracy of the padding helps to reduce decoder drift since the padded values are reference values for the motion compensation, errors may propagate to other predicted frames.

The video data may have been encoded according to one of the following standards: MPEG-4; VC-1; and H.264.

According to a third aspect of the present invention there is provided a video decoder adapted to down-sample video data in the frequency domain, and to carry out motion compensation on the down-sampled data in the frequency domain, the decoder being further adapted to transform the data back to the spatial domain after the step of motion compensation has been performed.

According to a fourth aspect of the present invention there is provided a video player comprising a decoder and a renderer, wherein the data is subject to an inverse transform within the renderer.

In embodiments of the invention, the inverse transform may comprise the IDCT.

In embodiments of the invention, the decoder may comprise a framestore in which data is stored in the form of DCT coefficients for example.

The invention will now be further described by way of example of only with reference to the accompanying drawings in which:

FIG. 1 is a schematic representation of a known video player in which down-sampling is carried out in the spatial domain;

FIG. 2 is a schematic representation of a second known video player;

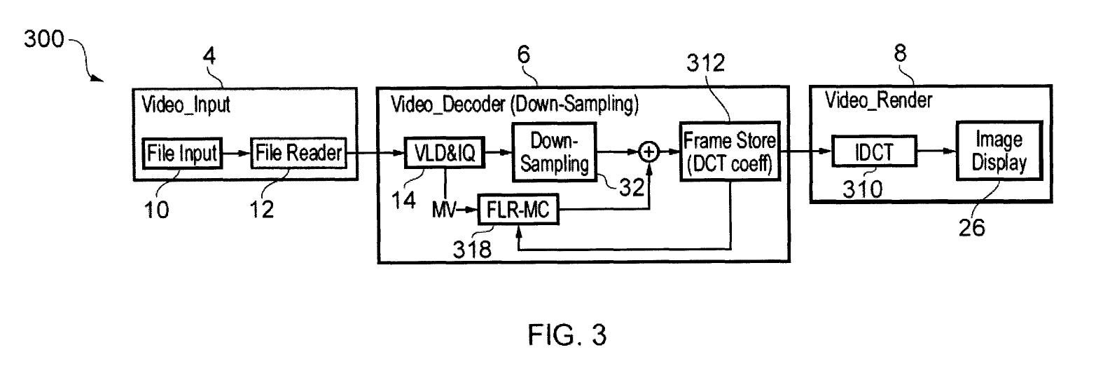

FIG. 3 is a schematic representation of a video player according to an embodiment of the present invention;

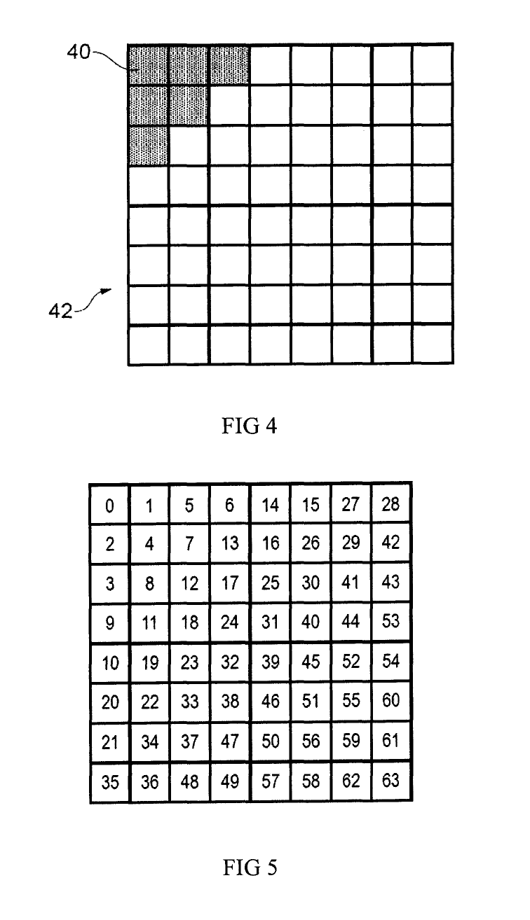

FIG. 4 is a schematic representation showing a scan-aligned down-sampling scheme that can be used in an embodiment of the present invention;

FIG. 5 is a graphical representation of a scan aligned scanning order;

FIG. 6 shows a butterfly structure for a 2D DCT; and

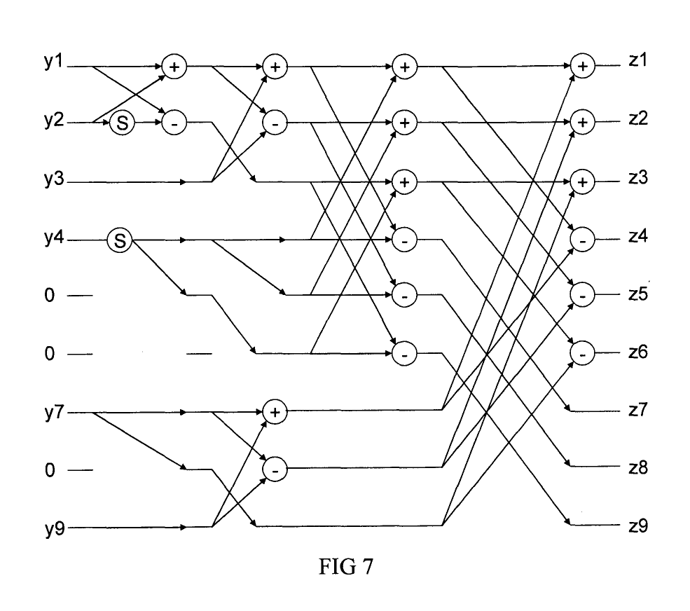

FIG. 7 shows a simplified butterfly structure.

Referring to FIG. 1 a known video player is designated generally by the reference numeral 2. The video player comprises a video input 4, a video decoder 6 and a video renderer 8.

The video input comprises a file input 10 and file reader 12.

Data is received into the video player 2 at file input 10 and is read by file reader 12. The data then enters the video decoder 6 where it is compressed by passing through a variable length decoder 14 and is subject to inverse quantisation. The data undergoes an IDCT (Inversed Discrete Cosine Transform) at 16 in order that it may be Inverse-transformed and thus converted to YUV data. Motion compensation 18 is applied at 22 and the YUV data then proceeds to the frame store 20 where it is held. Data then enters the video renderer 8 in order for an image to be rendered and displayed. Down-sampling thus occurs at 24 in the spatial domain since the data has already been Inverse-transformed at 16 and an image is displayed at 26.

Referring now to FIG. 2, a second known video player is illustrated and designated generally by the reference numeral 30. Parts of the video player 30 that correspond to parts of the video player 2 have been given corresponding reference numerals for ease of reference.

In the video player 30, the down-sampling is carried out in the video decoder 6 at 32. It is carried out in the DCT domain down-sampling since down-sampling occurs after VLD &IQ at 14 and before IDCT at 16. This is because the down-sampling is carried out on data in DCT domain. After IDCT at 16, the decoded YUV frame is stored at store 28. This data is used as a reference frame for the following frame of data. The MC is a spatial low resolution motion compensation (SLR-MC) process. This achieves motion compensation on the low resolution frame in the spatial domain.

The original resolution is the resolution of the source video. For example: 640×480 video. After a ½ downsampling, the resolution will change to 320×240. This 320×240 is known as low resolution. It compared to original the resolution (640×480).

Referring now to FIG. 3, a video player according to an embodiment of an aspect of the present invention is designated generally by the reference numeral 300. Parts of the video player 300 that correspond to parts of video players 2, 30 have been given corresponding reference numerals for ease of reference.

An important feature of the video player 300 is that the inverse DCT (IDCT) is taken out of the decoder loop 6 and is placed within the rendering process 8.

Since the IDCT operation has been moved out of the decoder loop 6, the decoder loop will now handle data in the frequency domain only. This means that motion compensation (MC) will operate in the frequency domain.

As will be explained more fully hereinbelow, this architecture has many advantages over other architectures of down-sampling decoders. This new methodology according to aspects of the present invention, of motion compensation in the DCT domain along with the down-sampled data will be referred to herein as frequency domain, low resolution, motion compensation (FLR-MC).

Since FLR-MC works in the frequency domain, all reference data and current data are DCT co-efficients and only the down-sampled DCT co-efficient of a frame (and not YUV data) will be stored during decoding process.

As explained above, the IDCT function transforms DCT coefficients into YUV data. Similarly, the DCT function transforms YUV data into DCT coefficients. By means of the present invention, it is possible to store data as DCT coefficients, and it is not necessary to store YUV data. Since the DCT has been moved out of the decoding loop and put in the rendering process all the data manipulated within the decoding loop are frequency domain data also described here has DCT coefficients, these resulting from the transformation of YUV data by the DCT operator. YUV coefficients are reconstructed from DCT coefficients using the Inverse DCT transform performed in DTC coefficients.

In the known video player described FIGS. 1 and 2, the frame stores (20) holds YUV data. These data are obtained from IDCT. The IDCT converts DCT data into YUV data. MC in FIG. 1 and SLR-MC in FIG. 2 both operate on YUV data to calculate a reference block in spatial domain. However, in the present invention, as shown in FIG. 3, the framestore holds DCT coefficients which are in the frequency domain.

In a down-sampling video player, the total amount of arithmetic operations is very much dependent on the down-sampling process. Moreover, it also determines directly the memory size of the frame buffer for storing the down-sampled DCT coefficient. In a full-resolution decoder, the decoder handles 8×8 DCT coefficients for each DCT block. As energy in the DCT domain concentrates around the low frequency data area, down-sampling in the frequency domain can be carried out by taking only the low frequency components of the DCT.

A conventional method of down-sampling in the DCT domain is carried out by taking N×N data samples from the top left of the block, where N is less than 8. This N×N square block of data is considered as first order down-sampling.

In the present invention, second order down-sampling is applied. Second order down-sampling is an operation of further down-sampling of the N×N data block obtained from first order down-sampling. Data obtained from second order down-sampling will not be limited to a rectangular or square data block, the data can be any data subset from N×N data block.

It will be shown hereinbelow that the architecture of the present invention can fully exploit the characteristic of second order down-sampling in reducing computation operations.

In the present embodiment of the invention, a special case of second order down-sampling is chosen and the choice of is based on the criterion to balance the need for a decent image quality against low computation operations in a mobile device.

Based on this criterion, a scan-align down-sampling scheme is chosen as a special case of second order down-sampling in the verification process. It is to be understood, however, that other down-sampling schemes could be used. A scan align scanning order is illustrated in FIG. 5.

In a scan-aligned down-sampling scheme, removal of high frequency components from the first order down-sampled block is carried out along the boundary of the inverse zigzag scan. In an MPEG4 decoder, almost all blocks use a zigzag scan in VLC (variable length coding) coding. Other scan methods (horizontal and vertical scan) are used only in intra block with AC prediction

With N=3 and using a scan-aligned down-sampling scheme, only 6 data samples in each 8×8 DCT coefficient block will be processed. FIG. 4 shows the 6 data positions 40 on a 8×8 block 42.

By taking only 6 data samples from a total of 64 data samples in a DCT block, the invention saves a large amount of frame buffer. By removing high frequency data samples, degradation in image quality is expected. However the degradation is less noticeable and deemed acceptable in mobile devices as the display screens of mobile devices are generally small. Moreover users of mobile devices in general attach higher priority to the smoothness of image sequence than the image definition.

The handling of only 6 data samples reduces the number of multiplications in the motion compensation of the present invention, and reduces unnecessary operations in the de-quantizer in the decoder which takes place after the VLD step in the decoder. Since only 6 out of 64 coefficients from each 8×8 DCT blocks are retrieved from the video compressed bit streams, de-quantization need only be performed on these 6 coefficients.

Motion compensation (MC) is the core module of a video player, and it consumes about 50% of computation resources in a conventional video decoder. Reducing the amount of computations in MC operation is an important consideration for improving total system performance.

Previously, down-sampling decoders such as the type illustrated in FIG. 2 have used methods of motion compensation that operate in the spatial domain, which in itself is in compliant with the MPEG decoder reference model. However such a model could not be exploited by the second order sampling carried out in the present invention, since motion compensation in the spatial domain needs to deal with N×N matrices of non-zero elements.

A solution to such issues is a new methodology in motion compensation, known herein as frequency domain low resolution motion compensation (FLR-MC).

FLR-MC operates in the frequency domain and operates on the down-sampled DCT data and the output data is still in DCT domain. Owing to the removal of the high frequency DCT coefficients by the second order down-sampling method of the present invention, the number of operations in MC is greatly reduced. This is the most significant advantage of FLR-MC over known spatial field low-resolution motion compensation (SLR-MC).

FLR-MC can be considered as a filter for generating current down-sampled DCT coefficients from reference down-sampled DCT coefficients, by using the motion vector of full-resolution frames. This filter is a matrix which transforms reference to current on down-sampled DCT coefficients.

To derive a suitable filter for FLR-MC, one must consider the problem of prediction drift caused by motion compensation with down-sampled data. This is a very serious artifact, and if not treated properly, the quality cannot be deemed acceptable. It is mainly due to non-ideal interpolation of sub-pel intensities and also the loss of high frequency data within a block.

A full discourse on this subject can be found in Paper 1. The paper focuses on Motion Compensation in the spatial (or time) domain and puts forward a proposal that the optimal set of filters for performing the low-resolution motion compensation is dependent on the choice of down-conversion filter.

FLR-MC is an extension of the motion compensation methodology disclosed in this paper from the spatial domain to the frequency domain. Derivation of the filter matrix for FLR-MC is described in the following paragraph.

### Notations:

For ease of comparison with the Paper 1, similar mathematical notations are used in the following derivations. For convenience we quote the definitions of the notation from the Paper 1.

Vectors will be denoted with an underline and matrices will be written with an uppercase letter. For the most part, input and output blocks are in the form of vectors and filters are in the form of matrices. For notational convenience, all of the analysis will be carried out in the 1D case since the results are readily extended to 2D by ordering input and output blocks lexicographically and making appropriate extensions in the down-conversion and motion-compensation. For the 1D analysis, a block will refer to an 8×1 vector, and a macro block will consist of two 8×1 vectors. To differentiate between vectors in the spatial and DCT domain, lowercase and uppercase variables will be used respectively. In the event that a matrix does not carry an alphabetic subscript, it is assumed to be in the same domain as the vector which it is operating on.

### Derivation:

The following arithmetic description is a 1D matrix representation. The 2D case can be derived by repeating the application for every row, and then for every column of each block.

1) In full-resolution motion compensation, the operation is expressed in matrix format as shown in (1) where a and b are two reference vector. The motion-compensated vector is h. And S_{a/b} represents the motion compensation algorithm of a standard decoder.

$$\underline{h} = [ \begin{matrix}{S}_{a} & {S}_{b}\end{matrix} ] [ \begin{matrix}\underline{a} \\ \underline{b}\end{matrix} ] . \qquad ( 1 )$$

2) If Y represents down-sampling algorithm, Ã and \tilde{B} are the output DCT coefficient vector through down-sampling operation, then

Ã=Ya,

\tilde{B}=Yb. (2)

3) Using the down-sampled DCT coefficient blocks as input to the FLR-MC, the following expression can be assumed:

$$\hat{\tilde{\underline{H}}} = [ \begin{matrix}{M}_{1} & {M}_{2}\end{matrix} ] [ \begin{matrix}\tilde{\underline{A}} \\ \tilde{\underline{B}}\end{matrix} ] \qquad ( 3 )$$

Where M₁ and M₂ denote the unknown frequency filters for performing FLR-MC.

4) According to the conclusion of Paper 1, the frequency filters M₁ and M₂ can be derived as follow:

M₁=YSₐY⁺,

M₂=YS_{b}Y⁺. (4)

Where

Y⁺=Y_{T}(YY^{T})⁻¹ (5)

5) In the present invention, the down-sampling operation is assumed:

Y=[Iₘ0]D₈ (6)

Y⁺=D₈^{T}[Iₘ0]^{T} (7)

Where D₈ is 8×8 block DCT transform. Iₘ represents a m×m (m<8) identity matrix. [Iₘ 0] represents m×1 data truncation.

In the matrices [M₁ M₂] of FLR-MC filters, the value of Y and Y⁺ are constant. The values M₁ and M₂ are decided by the values of Sₐ and S_{b} respectively. If motion vectors contain only integers and sub pixels, the Sₐ and S_{b} matrices would have 16 cases. Then in each case, the FLR-MC filters matrix contain m×2m elements. These elements keep to a rule. Take the following 4×8 matrix for example:

$$[ \begin{matrix}{M}_{1} & {M}_{2}\end{matrix} ] = [ \begin{matrix}{a}_{00} & - {a}_{10} & {a}_{20} & - {a}_{30} & 1 - {a}_{00} & {a}_{10} & - {a}_{20} & {a}_{30} \\ {a}_{10} & {a}_{11} & - {a}_{21} & {a}_{31} & - {a}_{10} & {a}_{15} & - {a}_{25} & {a}_{31} \\ {a}_{20} & {a}_{21} & {a}_{22} & - {a}_{32} & - {a}_{20} & {a}_{25} & {a}_{26} & - {a}_{36} \\ {a}_{30} & {a}_{31} & {a}_{32} & {a}_{33} & - {a}_{30} & {a}_{31} & {a}_{36} & {a}_{37}\end{matrix} ]$$

When 3×3 is chosen for the first order down-sampling, the FLR-MC filter matrix keeps to the same rule as follow:

$$[ \begin{matrix}{M}_{1} & {M}_{2}\end{matrix} ] = [ \begin{matrix}{a}_{00} & - {a}_{10} & {a}_{20} & 1 - {a}_{00} & {a}_{10} & - {a}_{20} \\ {a}_{10} & {a}_{11} & - {a}_{21} & - {a}_{10} & {a}_{24} & - {a}_{34} \\ {a}_{20} & {a}_{21} & {a}_{22} & - {a}_{20} & {a}_{34} & {a}_{35}\end{matrix} ]$$

The above filter matrix can only be found in FLR-MC in accordance with Equation 4. While in spatial domain low-resolution motion compensation, there has not been any obvious rule found in filter matrices.

As shown in the above matrix for FLR-MC, repetition of some data elements in the matrix will give additional reduction in multiplications operations.

It can be deduced from this section that FLR-MC is a key process in the present invention. A simple and elegant MC filter matrix that reduces down-sampled MC artifacts and computation complexity can be found only when MC operates in frequency domain.

In second order down-sampling, only p (p<m×m) data from a cut-out block of m×m will be extracted. Owing to the use of FLR-MC, the consequence of removing some data (m*m−p) samples from a cut-out block is a reduction of much matrix multiplication. For a 3×3 case in first order down-sampling, when only 6 data are extracted in scan-aligned down-sampling scheme, the multiplication will be reduced by about 48%.

In contrast, SLR-MC cannot offer such performance advantage, since it has to process all data elements in a down-sampled block. For SLR-MC, regardless of first order N×N or second order down-sampling scheme, it always has to handle N×N data samples.

Another advantage of the present invention stems from the fact that the IDCT process has been moved from the video decoder 6 to the video renderer 8.

Considering a video player system in a resource limited mobile device, the number of frames that are actually rendered successfully is very often less than the number of frames being decoded, especially when the player performs a jump operation, or decodes complex video frames which require computation resources at the limit or exceeding the platform capability. Under such circumstances, resources have been used for decoding but the frames are not rendered, this is a waste of CPU resources.

The architecture of the present invention effectively swaps the sequence of MC and IDCT. This allows IDCT operation to be integrated with the renderer. Such arrangement has advantages in a resource limited system, such as mobile telephones. In the present invention system, IDCT operates on m×m (m<8) down-sampled block instead of 8×8. It can be considered as part of the rendering process in HPD system and IDCT operation will be executed only when the player needs to output YUV image. This is referred to as inverse DCT just in time or JIT-IDCT.

During a jump operation, the present invention, as in any decoder system, generally does not jump directly to a key frame (I frame). In the present invention, IDCT will not be executed until the precise jump position is found and there is a need for rendering. In contrast, a standard decoder will decodes all the frames regardless of the need for rendering. In this the present invention will save CPU resources.

Reduction of CPU resource wastage can also be achieved when a complex frame is being decoded and the required resources is beyond the capability of the platform, the incomplete frame will be discarded by the renderer and IDCT operation will not be executed.

In embodiments of the present invention, Intra-coded video frames (“I-frames”) and Predictively-coded video frames (“P-frames”) are decoded using down-sampling and motion-compensation in the transform domain. However, frames encoded using bilinear prediction (“B-frames”) may be decoded using frequency-domain down-sampling but conventional image domain (that is, spatial domain) motion-compensation may be applied. This is because B-frames are not used as reference frames for subsequent prediction (in standards such as MPEG-4) and so errors in B-frames do not propagate. Consequently, the computational effort of performing motion-compensation in the frequency domain can safely be avoided, without significant degradation. The reference frames for motion compensation of a B-frame are previously decoded (inverse-transformed) images. The motion vectors to be applied to these images are obtained by scaling down the motion vectors received in the encoded bitstream (to take account of the reduced resolution of the decoded images). The difference image is inverse transformed in the loop, and the result is combined with the predicted (motion-compensated) image.

Note that in the presently described embodiment, run length decoding is performed on all coefficients, because of the need to find the end of a block. However, the sign and value is retrieved only for the coefficients that are to be retained by the down-sampling operation. Likewise, inverse quantization (IQ) is performed only on these coefficients, to avoid redundant computation.

It has been found beneficial to retain more coefficients in the down-sampling (that is, within the motion-compensation loop) than are actually used by the IDCT. For an 8×8 block-size, the following table shows exemplary numbers of coefficients retained at each stage:

TABLE 1
Numbers of coefficients retained at various resolutions

| | LUMA | | CHROMA | |
|---|---|---|---|---|
| | Number of | | Number of | |
| | coefficients | Number of | coefficients | Number of |
| | after second | coefficients | after second | coefficients |
| N | order down- | used in | order down- | used in |
| (Size of IDCT) | sampling | IDCT | sampling | IDCT |
| 4 | 10 | 10 | 4 | 4 |
| 3 | 8 | 6 | 4 | 4 |
| 2 | 3 | 3 | 4 | 3 |
| 1 | 3 | 1 | 4 | 1 |

In most cases, the coefficients are chosen according to the zig-zag scan pattern of FIG. 5. Thus, when keeping 10 coefficients, the triangular set of coefficients 0-9 will be used; when keeping 6 coefficients, the triangular set 0-5 will be used; and when keeping 3 coefficients, those numbered 0-2 will be used. However, the inventors have found that it may be helpful to keep one additional component each of horizontal and vertical frequency; or one additional component of diagonal frequency. In such cases, the down-sampling departs from the zig-zag pattern, but remains symmetrical about the diagonal frequency (that is, the down-sampling pattern and its transpose are identical). Thus, the set of 8 coefficients consists of the triangular set 0-5, plus horizontal/vertical coefficients 6 and 9; and the set of 4 coefficients consists of the triangular set 0-2, plus diagonal coefficient 4.

As can be seen in Table 1, fewer coefficients are retained for the chrominance than for luminance—both in the down-sampling and for the IDCT. This is because accurate reconstruction of the chroma is less important than luma, for acceptable image quality. A viewer watching the displayed video will be more sensitive to errors in the luminance signal.

Note also that, because the size (resolution) and number of coefficients used in the IDCT is decoupled from the size and resolution of the down-sampling pattern, it is possible to quickly change the resolution at the output. For example, if a smaller (or larger) picture is requested by the user, the IDCT resolution can be changed at the very next frame, by discarding coefficients (or zero-padding, respectively). The motion-compensation loop can then adapt more slowly: for example, the next I-frame to be extracted from the bitstream can be down-sampled at the new resolution, after which the motion-compensation loop can begin using the new resolution.

In an exemplary embodiment, the scaling ratio is 3:8. That is, each 8×8 block in the bitstream is decoded as a 3×3 block. The down-sampling retains 6 coefficients (0-5) for each block. Padding is performed after decoding of every frame. Padding can be performed in the frequency domain, by defining the padding filter in matrix form in the spatial domain and then transforming the operations into the frequency domain.

For example, for padding at the right-hand side of the video frame, the padding filter ‘f’ is

$$f = [ \begin{matrix}0 & 0 & 0 \\ 0 & 0 & 0 \\ 1 & 1 & 1\end{matrix} ]$$

Define the 3×3 block A of (downsampled) DCT coefficients as follows:

$$A = [ \begin{matrix}{a}_{00} & {a}_{01} & {a}_{02} \\ {a}_{10} & {a}_{11} & 0 \\ {a}_{20} & 0 & 0\end{matrix} ]$$

The DCT matrix for 3×3 is D3:

$${D}_{3} = [ \begin{matrix}\frac{1}{\sqrt{3}} & \frac{1}{\sqrt{3}} & \frac{1}{\sqrt{3}} \\ \frac{1}{\sqrt{2}} & 0 & - \frac{1}{\sqrt{2}} \\ \frac{1}{2} \cdot \sqrt{\frac{2}{3}} & - \sqrt{\frac{2}{3}} & \frac{1}{2} \cdot \sqrt{\frac{2}{3}}\end{matrix} ]$$

So to get the corresponding block ‘a’ of pixels in the spatial domain, we inverse transform A:

a=D₃^{T}*A*D₃

Padding block ‘p’ is the result of matrix multiplication of the block of pixels, a, by the filter, f:

p=a*f

So ‘P’ (the transform of ‘p’) is the padding block in transform domain:

$$\begin{matrix}P = {D}_{3} * p * {D}_{3}^{T} \\ = {D}_{3} * a * f * {D}_{3}^{T} \\ = {D}_{3} * {D}_{3}^{T} * A * {D}_{3} * f * {D}_{3}^{T} \\ = A * F\end{matrix}$$

### Where ‘F’ is

F=D₃*f*D₃^{T},

In this case, the result of this calculation is:

$$F = [ \begin{matrix}1.000 & 0 & 0 \\ - 1.225 & 0 & 0 \\ 0.7071 & 0 & 0\end{matrix} ]$$

In practice, it is preferable to use a full 3×3 block of coefficients to compute the padding. That is, 9 coefficients instead of 6 should be retained for the blocks at the border of the frame, for which padding will be performed. This results in a more faithful reconstruction of the padding values used at the encoder, and hence avoids drift.

The IDCT could be performed in a “brute force” fashion, using the matrix D₃ described earlier, above. However, computational efficiency can be increased if the calculation is decomposed into a series of simpler constituent operations. It is known to simplify a DCT of size 2^{m} because 8-points and 4-points 2D DCT are used frequently in image and video compression. However, in the present example, it is desired to decompose a 3×3 DCT. Such a decomposition can be derived based on the principles of the well-known Winograd decomposition, for a 2″-point DCT.

For the 1D transform, it can be shown that:

$$\begin{matrix}\begin{matrix}{D}_{3} = [ \begin{matrix}\frac{1}{\sqrt{3}} & \frac{1}{\sqrt{3}} & \frac{1}{\sqrt{3}} \\ \frac{1}{\sqrt{2}} & 0 & - \frac{1}{\sqrt{2}} \\ \frac{1}{2} \cdot \sqrt{\frac{2}{3}} & - \sqrt{\frac{2}{3}} & \frac{1}{2} \cdot \sqrt{\frac{2}{3}}\end{matrix} ] \\ = [ \begin{matrix}1 & 0 & 0 \\ 0 & 0 & 1 \\ 0 & 1 & 0\end{matrix} ] \cdot [ \begin{matrix}\frac{1}{\sqrt{3}} & 0 & 0 \\ 0 & \frac{1}{\sqrt{6}} & 0 \\ 0 & 0 & \frac{1}{\sqrt{2}}\end{matrix} ] \cdot [ \begin{matrix}1 & 1 & 1 \\ 1 & 1 & - 2 \\ 1 & - 1 & 0\end{matrix} ] \cdot [ \begin{matrix}1 & 0 & 0 \\ 0 & 0 & 1 \\ 0 & 1 & 0\end{matrix} ]\end{matrix} & \\ {D}_{3} = P \cdot D \cdot M \cdot P & \end{matrix}$$

P is a permutation matrix with no computational cost; D is a diagonal matrix; M is a matrix involving only addition and bit-shifting operations. Note that for the inverse transform we have:

D₃^{T}=(P·D·M·P)^{T}=P^{T}·M^{T}·D·P^{T}

It is well known that a 2D DCT transform can be separated into a first 1D DCT on the columns followed by 1D DCT on the rows. This however has been found not to provide the optimal simplification. Performing a full 2D transform is usually more complex to setup but more efficient, in this case, in terms of computation.

If x is the 3×3 block to transform then let xᵥ be the one dimensional 9-element vector consisting of the concatenated columns of the x 3×3 matrix.

X=D₃·x·D₃^{T} can now be written as

Xᵥ=(D₃ [symbol] D₃)·xᵥ

And similarly

x=D₃^{T}·X·D₃ can be written as:

xᵥ=(D₃^{T} [symbol] D₃⁷)·Xᵥ

### Consequently:

$$\begin{matrix}( {D}_{3}^{T} ⊗ {D}_{3}^{T} ) = ( ( {P}^{T} \cdot {M}^{T} \cdot D \cdot {P}^{T} ) ⊗ ( {P}^{T} \cdot {M}^{T} \cdot D \cdot {P}^{T} ) ) \\ = ( {P}^{T} ⊗ {P}^{T} ) \cdot ( {M}^{T} ⊗ {M}^{T} ) \cdot ( D ⊗ D ) \cdot ( {P}^{T} ⊗ {P}^{T} )\end{matrix}$$

With: (P^{T} [symbol] P^{T}) being a 9×9 permutation matrix; (D [symbol] D) being a 9×9 diagonal matrix; (M^{T} [symbol] M^{T}) being a 9×9 matrix of 1, 2 and 4, and therefore involving only additions and shift operations. This last computation can be described as butterfly processing as shown in FIG. 6. In terms of complexity: (P^{T} [symbol] P^{T}) does not cost anything, since it is just permutation of indices in tables of entry and output data. (D [symbol] D)costs 9 multiplications, since it is a 9×9 diagonal matrix. (M^{T} [symbol] M^{T}) costs 24 additions and 6 shifts operations of 1 bit, when following the butterfly processing shown in FIG. 6.

With second order down-sampling, some of the coefficients in the 3×3 block are zero, leading to further potential efficiency gains.

In the present example, we have 3 out of 9 coefficients which are always null. If we have:

$$X = [ \begin{matrix}X ( 1 ) & X ( 2 ) & X ( 3 ) \\ X ( 4 ) & X ( 5 ) & X ( 6 ) \\ X ( 7 ) & X ( 8 ) & X ( 9 )\end{matrix} ]$$

$${X}_{v}^{T} = [ X ( 1 ) , X ( 4 ) , X ( 7 ) , X ( 2 ) , X ( 5 ) , X ( 8 ) , X ( 3 ) , X ( 6 ) , X ( 9 ) ]$$

In the case of the second order DCT we will have:

$$X = [ \begin{matrix}X ( 1 ) & X ( 2 ) & X ( 3 ) \\ X ( 4 ) & X ( 5 ) & 0 \\ X ( 7 ) & 0 & 0\end{matrix} ]$$

$${X}_{v}^{T} = [ X ( 1 ) , X ( 4 ) , X ( 7 ) , X ( 2 ) , X ( 5 ) , 0 , X ( 3 ) , 0 , 0 ]$$

If Yᵥ is the resulting vector of the (P^{T} [symbol] P^{T}) permutation, we will have:

Yᵥ^{T}=[X(1),X(7),X(4),X(3),0,0,X(2),0,X(5)]

Consequently the multiplication by the diagonal matrix (D [symbol] D) will be limited to 6 multiplications. The butterfly pattern will simplified as shown in FIG. 7. This reduces the overall computational complexity to 18 additions and 2 shifts of 1 bit operations.

If there are more zeros in the 3×3 matrix of coefficients, further simplification becomes possible, by applying the same principles.

DCT data that are received by the decoder will have been encoded by an encoder with an 8×8 DCT and will be decoded by decoder with a 3×3 IDCT. Consequently there is a mismatch depending on the

$$\sqrt{\frac{2}{N}}$$

ratio in the definition of the DCT. This ratio is defined so that the transform matrices D_{N} are orthogonal (D_{N}·D_{N}^{T}=I_{N}). When considering the full encoding-decoding chain, data will go through the DCT and IDCT of same size. When doing an IDCT with a different size the data will not be correctly computed if the

$$\sqrt{\frac{2}{N}}$$

ratios are not taken into account.

This can be corrected in the decomposition of the D₃ matrix, by including a scaling factor, a:

xᵥ=(a·D₃^{T} [symbol] a·D₃^{T})·Xᵥ

### Consequently:

$$\begin{matrix}( a \cdot {D}_{3}^{T} ⊗ a \cdot {D}_{3}^{T} ) = ( a \cdot ( {P}^{T} \cdot {M}^{T} \cdot D \cdot {P}^{T} ) ⊗ a \cdot ( {P}^{T} \cdot {M}^{T} \cdot D \cdot {P}^{T} ) ) \\ = ( {P}^{T} ⊗ {P}^{T} ) \cdot ( {M}^{T} ⊗ {M}^{T} ) \cdot ( a \cdot D ⊗ a \cdot D ) \cdot ( {P}^{T} ⊗ {P}^{T} )\end{matrix}$$

Note that, for this specific case, the first coefficient of a·D₃^{T} [symbol] a·D₃^{T} is a power of two which will then lead to a shift operation instead of a multiplication. So final optimization leads to: 5 multiplications; 18 additions; and 3 shifts.

A similar derivation can be followed for other resolutions, such as a 4×4 block. Note that, in some instances, it may be desired to perform a 4×4 IDCT on a 3×3 DCT block, where the 3×3 block has been padded with zeros. This can be useful in the case of performing a scaling ratio in the IDCT in order to match a particular desired display resolution. The zero padding permits further simplification of the computation (in particular, the butterfly structure), because many calculations involving zeros do not need to be evaluated explicitly.

The IDCT need not be performed on blocks where the motion vector is null and the frame-difference is null. These blocks are unchanged, compared with the reference frame, and so it is wasteful to repeat the calculation. This idea can also be extended to non-null motion vectors, where the frame-difference is null. These are blocks which correspond exactly to a block in a different place in the reference image. The correct block in the (reduced-resolution) reference image can be found by scaling down and rounding the motion vector. Errors may be introduced by this approximation, but they will not propagate, since they are outside the motion compensation loop.

In a preferred embodiment, rounding control compensation is applied, to prevent drift in the motion compensation loop. Suitable rounding control techniques are described, for example, in Wu et al. (Ping-Hao Wu, Chen Chen, and Horner H. Chen, “Rounding Mismatch Between Spatial-Domain and Transform-Domain Video Codecs”, IEEE Transactions On Circuits And Systems For Video Technology, Vol. 16, No. 10, October 2006).

The examples described above were devised for an embodiment of the invention suitable for MPEG-4 encoded video. However, the same principles apply equally to other motion-compensated transform codecs. Examples of other codecs that have been tested include VC-1 and H.264. The latter is also known as MPEG-4 Advanced Video Coding (AVC). These other standards include some additional/different coding techniques, which can also be implemented in the transform domain.

H.264 defines an “intra” prediction mode in which blocks are predicted from adjacent, already-decoded blocks within the same frame. Using the same principles that were described above for motion compensation, it is possible to define filters in the frequency domain which implement the various types of intra prediction supported in the H.264 standard. This means that intra predicted blocks can be decoded in the transform domain in the same way as described earlier for the P-frames of an MPEG-4 stream.

The motion compensation processing in H.264 is different for half-pel interpolation. This uses a 6-tap filter, instead of simple averaging. However, it is straightforward to derive a transform domain implementation of this motion compensation filter, by using the same principles described previously above.

H.264 uses an integer transform, rather than the full precision DCT, to facilitate hardware implementation and avoid mismatch between encoder and decoder. The normative integer transform is not distributive over multiplication; therefore, it is necessary to deviate from the standard and use an approximation of the inverse transform which does have this distributive property. Once a distributive inverse transform is chosen, it will be straightforward for those skilled in the art to apply the principles outlined earlier above to derive suitable motion-compensation filters.

Those skilled in the art will find it straightforward to re-integrate the non-integer part of the H.264 transform to make it distributive, because the transform defined for H.264 is derived from the DCT (which is itself distributive). Note that the distributive version of the transform need only be used for the operations inside the motion-compensation loop—in particular, the derivation of suitable motion-compensation filters. It is desirable that the transform-domain operations inside the loop match the standard definitions as closely as possible, to avoid drift. Meanwhile, the inverse transform, which is used (outside the loop) to return the data to the spatial domain, is a reduced and adapted version of the inverse DCT. It is not necessary for this inverse transform to remain faithful to the standard, because any differences introduced outside the loop will not cause drift. The only desirable feature is to produce visually acceptable results for a human viewer.

VC-1 also uses a non-distributive integer transform, which should be replaced with an approximation, for the purposes of implementing the present invention.

In VC-1, four different sizes of transforms are used (4×4, 8×8, 4x8 and 8×4). These transforms are similar to the well known Discrete Cosine Transform (DCT) used in earlier video coding standards such as MPEG-2 and MPEG-4. They are however slightly modified so that the transforms are integer transforms, to facilitate efficient hardware implementations and avoiding mismatch the encoder and decoder.

Starting from the transforms used in the VC-1 standard, let us define:

$$T 8 = [ \begin{matrix}12 & 12 & 12 & 12 & 12 & 12 & 12 & 12 ; \\ 16 & 15 & 9 & 4 & - 4 & - 9 & - 15 & - 16 ; \\ 16 & 6 & - 6 & - 16 & - 16 & - 6 & 6 & 16 ; \\ 15 & - 4 & - 16 & - 9 & 9 & 16 & 4 & 15 ; \\ 12 & - 12 & - 12 & 12 & 12 & - 12 & - 12 & 12 ; \\ 9 & - 16 & 4 & 15 & - 15 & - 4 & 16 & - 9 ; \\ 6 & - 16 & 16 & - 6 & - 6 & 16 & - 16 & 6 ; \\ 4 & - 9 & 15 & - 16 & 16 & 15 & 9 & - 4\end{matrix} ] ;$$

$$T 4 = [ \begin{matrix}17 & 17 & 17 & 17 ; \\ 22 & 10 & - 10 & - 22 ; \\ 17 & - 17 & - 17 & 17 ; \\ 10 & - 22 & 22 & - 10\end{matrix} ] .$$

In order to achieve the distributivity property toward multiplication of the forward transforms, slight modification is needed. In this embodiment, the following matrices are used:

div4=sqrt(1/(T4*T4′))

div8=sqrt(1/(T8*T8′))

M44=div4*ones(4,4)*div4

M88=div8*ones(8,8)*div8

M48=div4*ones(4,8)*div8

M84=div8*ones(8,4)*div4

Now the modified forward transforms can be defined as:

A44=(T4*a44*T4′).*M44

A88=(T8*a88*T8′).*M88

A48=(T4*a48*T8′).*M48

A84=(T8*a84*T4′).*M84

With these modifications, it can be shown that the transform becomes distributive again, with respect to multiplication.

Similarly, because the in-loop deblocking filter in the VC-1 and H.264 standards are also non-linear processes, their effects can (at best) only be approximated in the transform domain.

Optionally, the decoding algorithm can be used to perform additional image processing and/or manipulation. Because the IDCT is outside the motion-compensation loop, there is a frequency-domain representation of every frame available before it is inverse transformed an displayed. In a conventional decoder, only I-frames are available in the frequency domain. Meanwhile for P-frames and B-frames, the motion-compensated frame-difference signal is available in the transform domain.

In embodiments of the present invention, this availability of every decoded frame in the transform domain can be exploited. Techniques for image processing in the DCT domain have been described, for example, in Merhav and Kresch (N. Merhav and R. Kresch, “Approximate convolution using DCT coefficient multipliers,” IEEE Trans. on Circuits and Systems for Video Technology, vol. CSVT-8, no. 4, pp. 378-385, August 1998). The present invention permits these (and other similar) techniques to be used with motion-compensated transform-coded video bitstreams.

In particular, in embodiments of the invention, it can be beneficial to apply sharpening to the decoded frames. This is because the down-sampling and corresponding reduction in resolution tends to result in blurring. The perceptual impact of this blurring can be reduced to some extent by a sharpening filter. One exemplary sharpening filter is the unsharp mask.

Considering pixels x(n,m) as input and y(n,m) as output, let us consider a high pass filter along each of the x-axis and y-axis:

zx(n,m)=2*x(n,m)−x(n,m−1)−x(n,m+1)

zy(n,m)=2*x(n,m)−x(n−1,m)−x(n+1,m)

The final output will be:

y(n,m)=x(n,m)+alpha*(zx(n,m)+zy(n,m))

Let us consider the matrices

$$z 1 = [ \begin{matrix}2 & - 1 & 0 & 0 & 0 & 0 & 0 & 0 ; \\ - 1 & 2 & - 1 & 0 & 0 & 0 & 0 & 0 ; \\ 0 & - 1 & 2 & - 1 & 0 & 0 & 0 & 0 ; \\ 0 & 0 & - 1 & 2 & - 1 & 0 & 0 & 0 ; \\ 0 & 0 & 0 & - 1 & 2 & - 1 & 0 & 0 ; \\ 0 & 0 & 0 & 0 & - 1 & 2 & - 1 & 0 ; \\ 0 & 0 & 0 & 0 & 0 & - 1 & 2 & - 1 ; \\ 0 & 0 & 0 & 0 & 0 & 0 & - 1 & 2\end{matrix} ]$$

$$z 2 = [ \begin{matrix}0 & 0 & 0 & 0 & 0 & 0 & 0 & - 1 ; \\ 0 & 0 & 0 & 0 & 0 & 0 & 0 & 0 ; \\ 0 & 0 & 0 & 0 & 0 & 0 & 0 & 0 ; \\ 0 & 0 & 0 & 0 & 0 & 0 & 0 & 0 ; \\ 0 & 0 & 0 & 0 & 0 & 0 & 0 & 0 ; \\ 0 & 0 & 0 & 0 & 0 & 0 & 0 & 0 ; \\ 0 & 0 & 0 & 0 & 0 & 0 & 0 & 0 ; \\ 0 & 0 & 0 & 0 & 0 & 0 & 0 & 0\end{matrix} ]$$

Let us consider three consecutive blocks a0, a1, a2. Horizontal filtering will then be z2*a0+z1*a1+z2′*a2. Vertical filtering will be a0*z2′+a1*z2+a2*z2. For simplification let us consider z3 such as:

$$z 3 = [ \begin{matrix}1 & - 1 & 0 & 0 & 0 & 0 & 0 & 0 ; \\ - 1 & 2 & - 1 & 0 & 0 & 0 & 0 & 0 ; \\ 0 & - 1 & 2 & - 1 & 0 & 0 & 0 & 0 ; \\ 0 & 0 & - 1 & 2 & - 1 & 0 & 0 & 0 ; \\ 0 & 0 & 0 & - 1 & 2 & - 1 & 0 & 0 ; \\ 0 & 0 & 0 & 0 & - 1 & 2 & - 1 & 0 ; \\ 0 & 0 & 0 & 0 & 0 & - 1 & 2 & - 1 ; \\ 0 & 0 & 0 & 0 & 0 & 0 & - 1 & 1\end{matrix} ] ;$$

Then the processing can be limited to the block and the full sharpening filter for a block will be:

b1=a1+alpha*(z3*a1+a1*z3)

If we now consider this in the transform domain, Z3=D8*z3*D8′, where Z3 is a diagonal matrix and

B1=A1+alpha*(Z3*A1+A1*Z3)

Let us then consider:

N3=ones(8,8)+alpha*(Z3*ones(8,8)+ones(8,8)*Z3).

We can show that:

B1=A1.*N3.

Here, the notation “.*” means than each element of one matrix is multiplied by the respective element of the other matrix. (This contrasts with normal matrix multiplication, denoted by “*”.) This multiplication operation can conveniently be combined with the multiplication factors in the first stage of the IDCT, in the decomposition already described above. This means that the sharpening does not require any additional computation.

Similar transform domain processing can be defined for blurring (smoothing) operations. Meanwhile, contrast can be adjusted by manipulating the DC coefficient in the transform domain independently of the nonzero-frequency coefficients. For example, a lookup table can be implemented which maps the DC coefficient to a new value in a non-linear fashion. Operations such as transposition, 90-degree rotation and mirroring (flipping) can also easily be applied in the transform domain.

The invention has been described primarily in terms of using the DCT to transform data from the spatial/time domain to the frequency domain, and the IDCT for inversely transforming the data back to the time/spatial domain from the frequency domain. However, it is to be understood that other methods for transforming the data to and from these two domains may be used.

The present invention provides a decoder that is scalable—from a bitstream encoded at one resolution, it can efficiently decode a picture at a different (especially lower) resolution. This is useful in a wide variety of applications, including but not limited to the following:
Playback of high-definition video on mobile devices, or standard-definition video on mobile devices with limited processing power;
Picture-in-picture display—one video stream can be displayed in reduced resolution, while another stream is played at normal resolution;
A mosaic of video thumbnails—for example, for selecting among a plurality of streams, or to replace a mosaic of still-image thumbnails;
Playback of multiple channels simultaneously—for example in split-screen mode;
Video-conferencing—to display multiple participants at different and/or reduced resolutions

As well as reducing the computational burden of decoding, embodiments of the invention can also be used to reduce power consumption. This is particularly significant for portable personal electronic devices. For example, a device may be configured to detect a low-battery condition and, in response, activate a reduced-resolution decoding mode according to the present invention. This may enable the device to continue to play video for longer, as battery-charge dwindles.

1. A method of decoding video data, comprising:
down-sampling the data in the frequency domain;
carrying out a motion compensation step on the down-sampled data, which motion compensation step is carried out in the frequency domain, and
transforming the data back to the spatial domain after the motion compensation step has been performed.

2. A method according to claim 1 wherein the down-sampling comprises carrying out a second order down-sampling process of the data.

3. A method according to claim 2 in which the down-sampling is a zig-zag scan aligned down-sampling scheme.

4. A method according to claim 1, wherein:
the down-sampling comprises retaining only a first partial set of coefficients from among a block of frequency-domain coefficients and discarding the other coefficients of the block, said first set being chosen according to a first pattern; and
the transforming of the data back to the spatial domain comprises applying an inverse transform to a second set of frequency-domain coefficients, said second set being chosen according to a second, different pattern.

5. A method according to claim 4, wherein the second set of coefficients is a proper subset of the first set of coefficients.

6. A method according to claim 1, wherein the down-sampling of the data comprises:
retaining only a partial set of luma coefficients from among a block of frequency-domain luma coefficients; and
retaining only a partial set of chroma coefficients from among a block of frequency-domain chroma coefficients,
wherein the set of chroma coefficients contains fewer coefficients than the set of luma coefficients.

7. A method according to claim 1, further comprising decoding successive first and second frames of video data, wherein the transforming of the data back to the spatial domain is performed at a first resolution for the first frame and a second, different resolution for the second frame.

8. A method according to claim 1, further comprising, in the transforming of the data back to the spatial domain, applying additional processing to the video data as part of the inverse transform.

9. A method according to claim 8, wherein the additional processing comprises at least one of: sharpening; blurring; rotating; mirroring; transposing; translating; brightness change; and contrast change of a frame of the video data.

10. A method according to claim 1, wherein, in the down-sampling of the data:
a first number of coefficients are retained in a first block in the interior of a frame; and
a second, greater number of coefficients are retained in a second block at the border of the frame.

11. A method according to claim 1, wherein the video data is encoded according to one of the following standards: MPEG-4; VC-1; and H.264.

12. A video decoder, comprising:
an element that down-samples video data in the frequency domain, and
an element that performs motion compensation on the down-sampled data in the frequency domain,
wherein the decoder transforms the data back to the spatial domain after the motion compensation has been performed.
